(19) United States
(12) Patent Application Publication
(10) Pub. No.: US 2012/0139730 A1
(43) Pub. Date: Jun. 7, 2012

(54) ELECTRONIC ARTICLE SURVEILLANCE SYSTEM

(75) Inventor: Sean Philip Kearney, Marlton, NJ (US)

(73) Assignee: Metrologic Instruments, Inc., Blackwood, NJ (US)

(21) Appl. No.: 12/959,500

(22) Filed: Dec. 3, 2010

(51) Int. Cl. G08B 13/14

(52) U.S. Cl. 340/572.8

(57) ABSTRACT

An electronic article surveillance (EAS) system includes: a plurality of conductors arranged into an EAS coil and disposed within a flexible, insulation strip; an adhesive layer for attaching to a mounting side of the insulation strip to a device; and, a transmitter/receiver connected to the plurality of conductors for pairing the EAS coil with an EAS tag.

### FIELD OF THE INVENTION

This invention relates to the field of electronic article surveillance (EAS) systems, and in particular, an improved EAS coil.

### BACKGROUND

Electronic article surveillance (EAS) systems are used for inventory control and to prevent theft and similar unauthorized removal of articles from a controlled area. Electronic article surveillance systems allow the identification of a marker or tag within a given detection region. EAS systems have many uses, but most often they are used as security systems for preventing shoplifting in stores or removal of property in office buildings. EAS systems come in many different forms and make use of a number of different technologies. The EAS systems typically utilize interrogation zones that must be traversed to remove articles from the controlled area. An electronic article surveillance system detectable label is attached to an article that is to be protected. When an unauthorized article removal is attempted, the EAS system detects the label as the article traverses the interrogation zone. The electronic article surveillance responds to the detected label with an alarm condition and a preselected action is taken. When an article is properly purchased or otherwise authorized for removal from the protected area, the EAS marker is either removed or deactivated. If the EAS marker is not removed or deactivated, the electromagnetic field causes a response from the EAS marker in the interrogation zone. A typical EAS system includes a transmitting and receiving antenna electronic detection unit, markers and/or tags, and a detacher or deactivator.

Transmitting and receiving antennas, often referred to as a transmitter/receiver pair, are usually mounted in floors, walls, ceilings or free standing pylons. These are necessarily fixed mounting positions. The articles, on the other hand, may be carried through the field of the interrogating signal in any orientation, and accordingly, so may the tags or markers.

An antenna acting as a receiver detects the EAS marker's response indicating an active marker is in the interrogation zone. An associated controller provides an indication of this condition such that appropriate action can be taken to prevent unauthorized removal of the item from the protected area.

The markers and/or tags have special characteristics and are specifically designed to be affixed to or embedded in merchandise or other objects sought to be protected. Electronic article surveillance (EAS) systems have employed either reusable EAS tags or disposable EAS tags to monitor articles. The reusable labels normally placed on the goods at the commercial establishment by a clerk and are removed from the goods by the clerk with a special tool before the customer exits the store. The label is then reused by having the clerk place the label on another article. The disposable tags are generally attached to the packaging by adhesive or are disposed inside the packaging. These tags remain with the articles and must be deactivated before they are removed from the store by the customer. Deactivation devices use coils which are energized to generate a magnetic field of sufficient magnitude to render the EAS tag inactive.

Efforts regarding such systems have led to continuing developments to improve their versatility, practicality and efficiency.

### BRIEF DESCRIPTION OF THE DRAWINGS

FIG. 1 is a top view of an exemplary EAS coil.

FIG. 2 is a cross-sectional view taken along lines 2-2 of FIG. 1.

FIG. 3a is a perspective view of an exemplary EAS system.

FIG. 3b is an exploded perspective view of a portion of the EAS system shown in FIG. 3a.

FIG. 3c is an exploded cross-sectional view of a portion of the EAS system shown in FIG. 3a.

FIG. 3d is a perspective view of an exemplary EAS coil in the EAS system shown in FIG. 3a.

FIG. 4 is a schematic block diagram of an exemplary EAS system.

### DETAILED DESCRIPTION

Reference will now be made to exemplary embodiments of the invention which are illustrated in the accompanying drawings. This invention, however, may be embodied in various forms and should not be construed as limited to the embodiments set forth herein. Rather, these representative embodiments are described in detail so that this disclosure will be thorough and complete, and will fully convey the scope, structure, operation, functionality, and potential of applicability of the invention to those skilled in the art. Wherever possible, the same reference numbers will be used throughout the drawings to refer to the same or like parts.

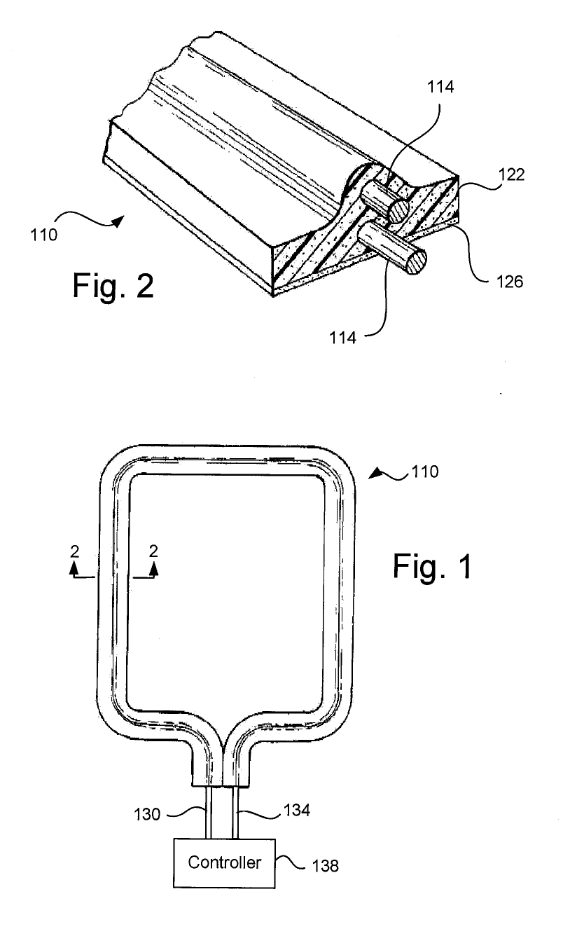

An exemplary EAS coil or antenna 110 configuration illustrated in FIGS. 1 and 2 is at least one conductor or wire 114, 118 arranged in a loop or coil and encased in an insulation strip 122. Exemplary wires are large gauge conductive coil wire co-molded with or molded into insulation material. Arrangement of the wires may be in the form of a pair of planar loops forming a Helmholtz coil wherein magnetic field lines will be approximately parallel in their center.

Exemplary insulator materials for the strip are elastomers, thermoplastic, natural rubber, polyisoprene, halobutyl rubbers, synthetic rubbers such as BIIR, BR, CIIR, CR, CSM, ECO, EP, EPDM, FKM, FVQM, HNBR, IR, IIR, MVQ, NBR, PU, SBR, SEBS, SI, XNBR or other rubber or rubber type materials and compounds that are flexible and can be molded or formed to have a low profile.

At least one mounting side of the insulation strip 110 may have an adhesive layer 126 attached or disposed thereon. An exemplary adhesive layer is comprised of a mixture in a liquid or semi-liquid state that adheres or bonds items together. Adhesives may come from either natural or synthetic sources. An exemplary adhesive layer may be an adhesive tape, such as pressure sensitive tape, water sensitive tape, heat sensitive tape. Adhesive tape may be one of many varieties of backing materials coated with an adhesive. Many types of adhesives may be used. The adhesive tape may have a covering adhesive protective film that is removed to adhere the strip to a desired surface on a product or device. Other adhesives may be utilized.

Pressure sensitive tape, PSA tape, self stick tape or sticky tape consists of a pressure sensitive adhesive coated onto a backing material such as paper, plastic film, cloth, or metal foil. It is sticky (tacky) without any heat or solvent for activation and adheres with light pressure. These tapes usually require a release agent on their backing or a release liner to cover the adhesive.

Water sensitive tape, water activated tape, gummed paper tape or gummed tape is starch, or sometimes animal glue based, adhesive on a paper backing which becomes sticky when moistened.

Heat activated tape is usually tack-free until it is activated by a heat source.

In an exemplary embodiment, the adhesive layer may be applied to the mounting surface of the coil by spraying, painting, coating or another manner so that the adhesive layer is integral with the insulation layer. A removable coating layer may be then applied to the mounting surface of the adhesive layer and removed just prior to installation of the coil on a surface.

The ends of the wires may have terminals or contacts 130, 134 to connect to a EAS controller or EAS transmitter/receiver 138 to wirelessly pair with an EAS tag 198.

The EAS antenna may be referred to as an EAS tape that may be packaged in the form of a roll of tape or shaped into a reticular, square, circular, rectangular, oval or any shape desired by an integrator. The benefit of the “tape” like nature is that the coil may be applied practically anywhere in or on an existing end user device making it easy to integrate or retrofit an EAS coil into an existing platform.

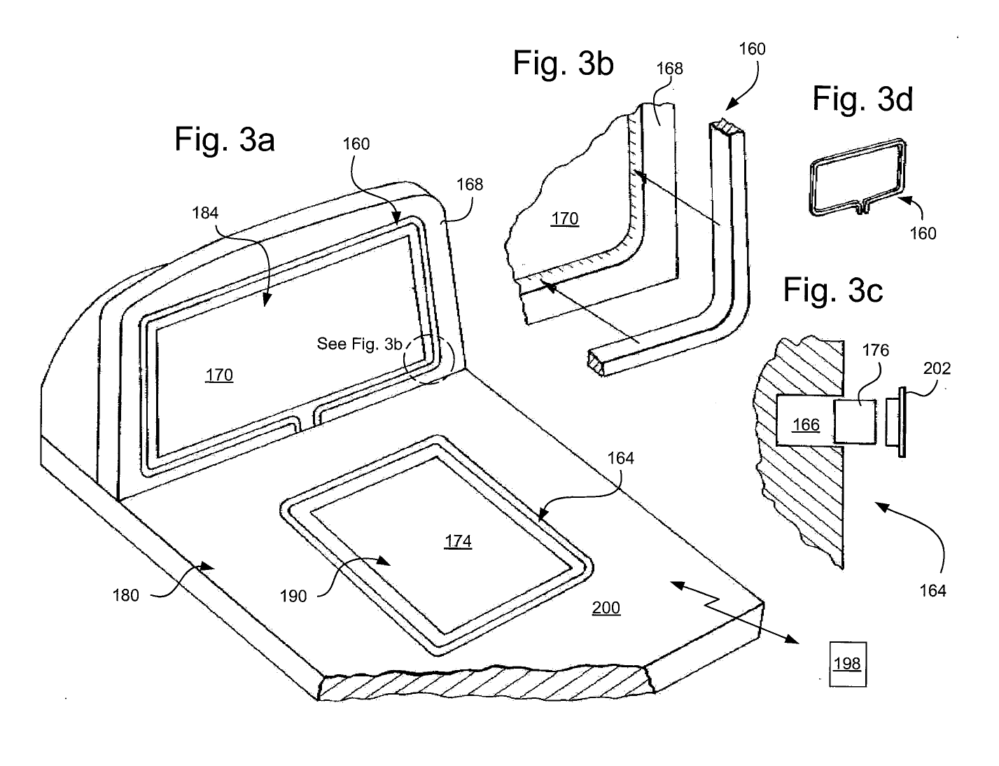

Exemplary EAS coils 160, 164 illustrated in FIGS. 3a-3d may be inserted into inlay tracks 166. The inlay tracks may reside in frames or housings 168 around scanning windows 170, 174 of a scanning device 180. The conductors 176 may be capped once inserted into a track with a sealing cap 202. The term “scan” or “scanning” refers to reading or extracting data from an information bearing indicia (or symbol). Scanning devices (also referred to as scanners, laser scanners, image readers, indicia readers, etc.) read data represented by printed or displayed information bearing indicia (IBI), (also referred to as symbols, symbology, bar codes, etc.) For instance one type of a symbol is an array of rectangular bars and spaces that are arranged in a specific way to represent elements of data in machine readable form. Indicia reading devices typically transmit light onto a symbol and receive light scattered and/or reflected back from a bar code symbol or indicia. The received light is interpreted by a processor which performs signal and/or image processing to extract the data represented by the symbol. Optical indicia reading devices typically utilize visible or infrared light. Laser indicia reading devices typically utilize transmitted laser light.

In an exemplary EAS system, coils 160, 164 are arranged to be perpendicular Helmholtz coils which may be described as a perpendicular figure eight configuration.

An exemplary scanning system 180 is a bi-optic laser scanner with both vertical 184 and horizontal 190 scan sections. An exemplary system is configured to have a deep slot 166 or channel that surrounds the window surfaces 170, 174 (scan areas) of the unit in which EAS coils are disposed. These slots may be molded into the plastic housing or formed in a metal platter 200. These channels may be left empty when the EAS solution is not present and a plastic insert put in its place.

In an exemplary embodiment the transmitter phases are interlaced to provide alternating transmissions from the two EAC coils for maximizing the system performance for all orientations of markers in an interrogation zone.

In an exemplary embodiment, the transmitter drives the EAS coils at two frequencies.

When manufacturing or upgrading an EAS detection unit an exemplary EAS coil 176 is dimensioned such that it has to be “snapped” into an empty channel 166 and an insulating cap 202 “snapped” in front. Coil 176, channel 166 and cap 202 are dimensioned such that they mate with one another in a tight fitting arrangement.

In an exemplary embodiment, the EAS coil may be a rigid coil. This coil may be formed from highly conductive metal material that may be bent and shaped with any gauge as desired. Multiple coil solutions may be found by increasing the depth of the channels\slots and inserting a sandwiched pair of rigid EAS coils.

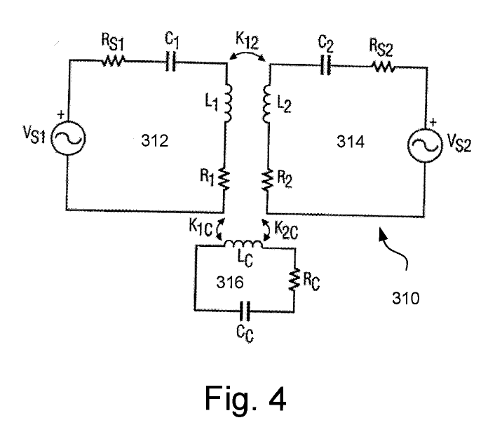

An exemplary transmitter-antenna circuit 310 is shown in FIG. 4. Inductors L₁ and L₂ represent the inductance of two transmitter coils 312 and 314. Resistors R₁ and R₂, represent the respective series resistances of the transmitter coils 312 and 314. Capacitors C₁ and C₂ are used to tune the resonant frequency to the operating system frequency. Vₛ₁ and _{Rs1} represent the output voltage and internal source resistance for one antenna driver. Vₛ₂ and Rₛ₂ represent the output voltage and internal source resistance for a second antenna drivers. The compensation loop or coil 16 needed for in-phase tuning is represented by inductor L_{C}, resistor R_{C}, and capacitor C_{C}. The coupling between the transmitter coils 312 and 314 is represented by K₁₂. The coupling between the compensation coil 316 and each of the transmitter coils 312 and 314 is represented by K₁ and K_{w}.

The detection for all these tags depends on their orientation relative to the detection loops. For a pair of planar loops forming a Helmholtz coil, magnetic field lines will be approximately parallel in their center. Orienting the tag so that no magnetic flux from the coils crosses them will prevent detection, as the tag won't be coupled to the coils. This shortcoming, documented in the first EAS patents, can be solved by using multiple coils or by placing them in another arrangement such as a figure-of-eight. Sensitivity will still be orientation-dependent but detection will be possible at all orientations.

In view of the wide variety of exemplary embodiments to which the principles of the present invention can be applied, it should be understood that the illustrated exemplary embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular exemplary embodiment or subject matter is considered to be disavowed herein.

1. An electronic article surveillance (EAS) system comprising:
a plurality of conductors arranged into an EAS coil and disposed within a flexible, insulation strip;
an adhesive layer for attaching to a mounting side of the insulation strip to a device; and,
a transmitter/receiver connected to the plurality of conductors for pairing the EAS coil with an EAS tag.

2. An EAS system in accordance with claim 1, wherein the EAS coil is molded into the insulation strip.

3. An EAS system in accordance with claim 1, wherein the plurality of conductors are configured as planar loops that form a Helmholtz coil.

4. An EAS system in accordance with claim 1, wherein the insulation strip comprises at least one of the following: elastomers; thermoplastic; natural rubber; polyisoprene; halobutyl rubbers; synthetic rubbers such as BIIR; BR; CIIR; CR; CSM; ECO; EP; EPDM; FKM; FVQM; HNBR; IR; IIR; MVQ; NBR; PU; SBR; SEBS; SI and XNBR.

5. An EAS system in accordance with claim 1, wherein the adhesive layer comprises at least one of the following: adhesive tape; such as pressure sensitive tape; water sensitive tape and heat sensitive tape.

6. An EAS system in accordance with claim 1, wherein the adhesive layer comprises at least one of the following: water sensitive tape; water activated tape; gummed paper tape; and an adhesive on a paper backing which becomes sticky when moistened.

7. An EAS system in accordance with claim 1, wherein the EAS system is disposed around a scanning window of a scanning device.

8. An EAS system in accordance with claim 1, wherein the EAS system is disposed in an inlay track.

9. An EAS system in accordance with claim 1, wherein the EAS system is disposed in an inlay track residing around a scanning window of a scanning device.

10. An EAS system in accordance with claim 1, wherein the EAS system is disposed in an inlay track residing around a scanning window of a scanning device and further comprising a sealing cap for sealing the EAS coil in the inlay track.

11. An EAS system in accordance with claim 1, wherein the EAS coil is configured to be snapped into the inlay track.

12. An EAS system in accordance with claim 1, further comprising:
a plurality of conductors arranged into a second EAS coil and disposed within a second flexible, insulation strip;
a second adhesive layer for attaching to a mounting side of the insulation strip to a device; and,
a second transmitter/receiver connected to the plurality of conductors for pairing the EAS coil with the EAS tag,
wherein the EAS coil and second EAS coils are arranged to be perpendicular Helmholtz coils.

13. An electronic article surveillance (EAS) system comprising:
a plurality of conductors arranged into an EAS coil and disposed within an inlay strip; and,
a transmitter/receiver connected to the plurality of conductors for pairing the EAS coil with an EAS tag.

14. An EAS system in accordance with claim 13, wherein the plurality of conductors are configured as a planar loop that forms a Helmholtz coil.

15. An EAS system in accordance with claim 13, wherein the EAS system is disposed around a scanning window of a scanning device.

16. An EAS system in accordance with claim 13, wherein the EAS system is disposed in an inlay track residing around a scanning window of a scanning device.

17. An EAS system in accordance with claim 13, wherein the EAS system is disposed in an inlay track residing around a scanning window of a scanning device and further comprising a sealing cap for sealing the EAS coil in the inlay track.

18. An EAS system in accordance with claim 13, wherein the EAS coil configured to be snapped into the inlay track.

19. An EAS system in accordance with claim 13, further comprising:
a plurality of conductors arranged into a second EAS coil and disposed within an inlay strip; and,
a second transmitter/receiver connected to the plurality of conductors for pairing the second EAS coil with the EAS tag,
wherein the EAS coil and second EAS coils are arranged to be perpendicular Helmholtz coils.
